(19) United States
(12) Patent Application Publication
(10) Pub. No.: US 2024/0320849 A1
(43) Pub. Date: Sep. 26, 2024

(54) INSPECTING METHOD AND INSPECTING DEVICE

(71) Applicant: Panasonic Intellectual Property Management Co., Ltd., Osaka (JP)

(72) Inventor: SHINYA NAKASHIMA, Kyoto (JP)

(21) Appl. No.: 18/677,993

(22) Filed: May 30, 2024

Related U.S. Application Data
(63) Continuation of application No. PCT/JP2022/029596, filed on Aug. 2, 2022.

(30) Foreign Application Priority Data
Dec. 7, 2021 (JP) 2021-198581

(51) Int. Cl. G06T 7/62; G06T 5/50; G06T 7/00; G06V 10/141; G06V 10/764

(52) U.S. Cl. CPC G06T 7/62; G06T 5/50; G06T 7/0004; G06V 10/141; G06V 10/764; G06V 2201/07

(57) ABSTRACT

The inspecting device includes a lighting device, an imaging device that images a sheet and outputs an image, movement means, and an image processing device. The lighting device irradiates the sheet with light a plurality of times in one imaging time. The movement means changes relative positions of the lighting device and the imaging device and the sheet in one imaging time. The image processing device extracts a plurality of images of a target object included in the image output by the imaging device, and combines the plurality of extracted images of the target object to determine a size of target object E.

### TECHNICAL FIELD

The present disclosure relates to an inspecting device and an inspecting method for an inspected object.

### BACKGROUND ART

In a device field such as a semiconductor, an electronic device, and a secondary battery, a defect detection device that detects a target object (foreign matter, defect, or the like) in an inspected object using a photoelectric conversion type image sensor is known.

In recent years, in these fields, due to high accuracy and miniaturization of products, sizes of foreign matters and defects in an inspected object have been reduced. In addition, there is a demand for improvement in production efficiency and quality, and accordingly, there is a demand for an increase in manufacturing process speed, improvement in yield, and the like. In order to increase the manufacturing process speed and improve the yield, high resolution and high responsiveness of the image sensor are required.

Production of a high-resolution and highly responsive image sensor requires a large development cost and a development period. Therefore, in PTL 1, a high-speed detector is realized by arranging a plurality of image sensors and simultaneously processing the image sensors.

### CITATION LIST

### Patent Literature

PTL 1: Japanese Patent No. 5172162

### SUMMARY OF THE INVENTION

Meanwhile, in PTL 1, in order to accurately detect a target object, a plurality of images output from an image sensor is combined to generate a high-definition image. In PTL 1, images are combined after the positions of a plurality of images are offset (corrected) based on the arrangement of the image sensors.

However, for example, in a case where the direction of the light emitted by the lighting device is not constant, or in a case where the inspected object is three-dimensional, there is a case where how the light strikes the inspected object is not constant. In such a case, in a plurality of images output from the image sensor, there is a possibility that the position of the target object is greatly shifted. Therefore, there is a possibility that it is not possible to correct the positional shift of the target object and to detect the target object by correcting the positions of the plurality of images based on the arrangement of the image sensors.

In particular, when an inspected object is inspected while the inspected object is conveyed, the position shift of the target object is likely to occur.

An object of the present invention is to improve detection reproducibility and detection probability of a target object in an inspected object.

In order to achieve the above object, an inspecting method according to an exemplary embodiment of the present disclosure is an inspecting method for detecting a target object included in an inspected object by capturing an image of the target object with an inspecting device, the inspecting device including: an imaging device that captures an image of the inspected object and outputs the image; a lighting device; movement means; and an image processing device, and the method including: an irradiation step of irradiating, by the lighting device, the inspected object with light a plurality of times in one imaging time; a movement step of changing, by the movement means, relative positions of the lighting device, the imaging device, and the inspected object in the one imaging time; and a determination step of extracting, by the image processing device, a plurality of images of the target object included in the image output by the imaging device, and combining the plurality of extracted images of the target object to determine a size of the target object.

According to the present disclosure, it is possible to improve the detection reproducibility and the detection probability of the target object in the inspected object.

### BRIEF DESCRIPTION OF THE DRAWINGS

FIG. 1 is a side view of an inspecting device according to a first exemplary embodiment.

FIG. 2 is a plan view of the inspecting device according to the first exemplary embodiment.

FIG. 3 is a plan view illustrating a configuration of an imaging element according to the first exemplary embodiment.

FIG. 4 is a timing chart illustrating an imaging timing of an imaging device, an irradiation timing of a lighting device, and a drive timing of an actuator in the inspecting device according to the first exemplary embodiment.

FIG. 5 is a flowchart for explaining an overall operation flow of an image processing device according to the first exemplary embodiment.

FIG. 6 is a diagram illustrating an example of an image of a sheet captured by the imaging element according to the first exemplary embodiment.

FIG. 7 is a diagram illustrating an example of an image of a sheet captured by the imaging element according to the first exemplary embodiment.

FIG. 8 is a diagram illustrating an example of a luminance value of a sheet imaged by the imaging element according to the first exemplary embodiment.

FIG. 9 is a flowchart illustrating a flow of generation processing of a corrected image of the image processing device according to the first exemplary embodiment.

FIG. 10 is a timing chart illustrating an imaging timing of the imaging device, an irradiation timing of the lighting device, and a drive timing of the actuator in the inspecting device according to a second exemplary embodiment.

FIG. 11 is a flowchart for explaining an overall operation flow of an image processing device according to the second exemplary embodiment.

FIG. 12 is a diagram illustrating an example of an image of a sheet captured by an imaging element according to the second exemplary embodiment.

FIG. 13 is a diagram illustrating an example of an image of a sheet captured by the imaging element according to the second exemplary embodiment.

FIG. 14 is a diagram illustrating an example of a luminance value of an extracted image according to the second exemplary embodiment.

FIG. 15 is a diagram illustrating an example of a luminance value of an extracted image according to the second exemplary embodiment.

FIG. 16 is a flowchart for explaining a flow of grouping processing of the image processing device according to the second exemplary embodiment.

FIG. 17 is a diagram for explaining generation processing of an original extracted image according to the second exemplary embodiment.

FIG. 18 is a flowchart for explaining a flow of physical property determination processing of the image processing device according to the second exemplary embodiment.

FIG. 19 is a graph plotting reflectance according to the second exemplary embodiment.

FIG. 20 is a diagram for explaining generation processing of a corrected image of the image processing device according to the second exemplary embodiment.

### DESCRIPTION OF EMBODIMENTS

Hereinafter, exemplary embodiments of the present invention will be described in detail with reference to the drawings. The following description of preferred exemplary embodiments is merely exemplary in nature and is not intended to limit the present invention, its applications, or its applications.

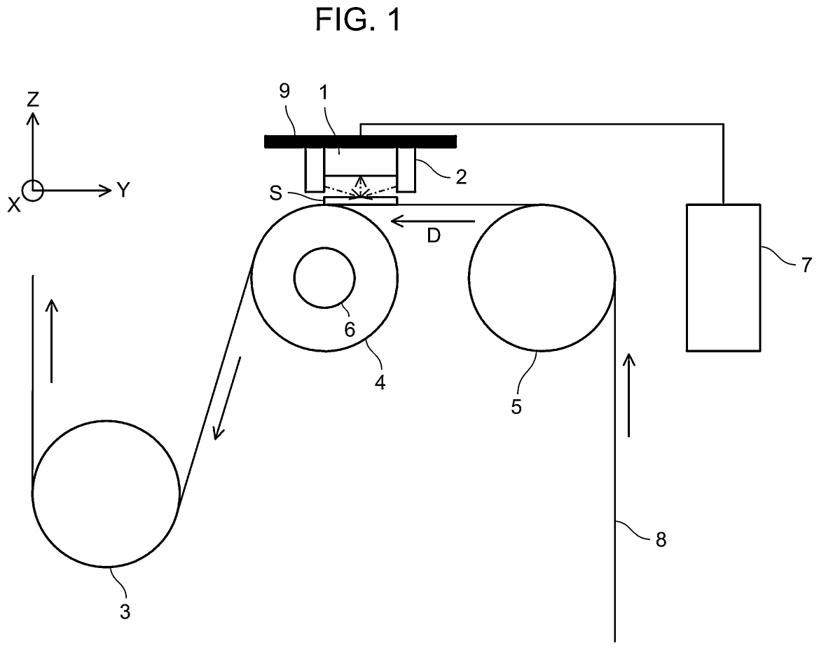

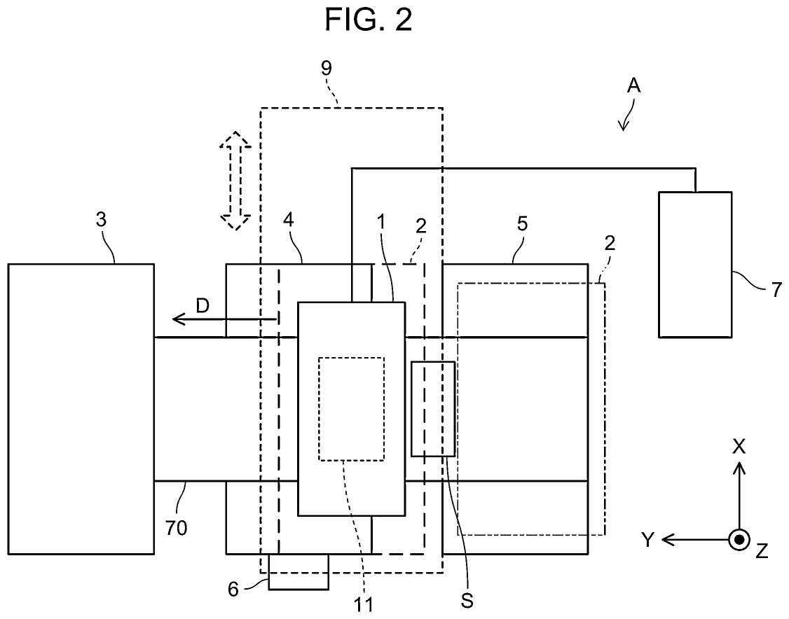

FIG. 1 is a side view of an inspecting device, and FIG. 2 is a plan view of the inspecting device. As illustrated in FIGS. 1 and 2, inspecting device A includes imaging device 1, lighting device 2, rollers 3 to 5 (movement means), rotary encoder 6, image processing device 7, and actuator 9 (movement means). Conveying belt 8 is wound around the outer periphery of rollers 3 to 5.

Inspecting device A inspects sheet S (inspected object). Sheet S is used, for example, in a device field such as semiconductors, electronic devices, and secondary batteries. Note that, in the following description, a case where the inspected object has a sheet shape will be described as an example, but the inspected object may not have a sheet shape. Furthermore, when sheet S is a long object, sheet S is wound around rollers 3 to 4 instead of conveying belt 8. Then, sheet S is conveyed in the direction of arrow D by rollers 3 to 5.

Inspecting device A detects target object E such as a defect or a foreign substance included in sheet S. The defect includes, for example, not only an incomplete portion or a deficient portion at the time of production of sheet S, such as a short circuit or a disconnection in sheet S to be inspected, but also damage (for example, a scratch mark due to contact between sheet S and another member) to sheet S. When detected target object E is larger than a predetermined size, the inspecting device determines that the target object is included in sheet S. Note that sheet S is conveyed in a direction of an arrow D indicated by a solid line in FIGS. 1 and 2 in a state of being placed on conveying belt 8.

Imaging device 1 includes imaging element 11 and photographs sheet S conveyed by conveying belt 8. Here, imaging device 1 is configured as an area sensor that photographs entire sheet S between rollers 4 and 5.

Imaging device 1 transmits a pixel signal output from imaging element 11 to image processing device 7. Note that, in the following description, a scanning direction of imaging device 1 is an X direction, a sub-scanning direction of imaging device 1 is a Y direction, and a direction perpendicular to the X direction and the Y direction is a Z direction.

Lighting device 2 includes, for example, a light source including an LED, a laser, a halogen light source, and the like, and irradiates a scanning region (sheet S) of imaging device 1 with light between rollers 4 and 5. Specifically, lighting device 2 is installed such that the light irradiation direction has an incident angle of about 10° with respect to conveying belt 8. Furthermore, imaging device 1 and lighting device 2 are configured by a dark field optical system so that light emitted from lighting device 2 does not directly enter imaging element 11. Imaging device 1 and lighting device 2 may be configured as a bright field optical system, but are preferably configured as a dark field optical system. With the configuration of the dark field optical system, lighting can be applied to target object E at a low angle, so that the base of target object E does not shine (the brightness of the base (ground level) where there is no foreign substance becomes low gradation). As a result, the luminance of target object E becomes higher than that of the base, and the SN (signal noise (luminance of foreign substance/luminance of base)) ratio increases, so that a clear image of target object E can be generated.

Furthermore, imaging device 1 and lighting device 2 are provided with actuator 9 that moves imaging device 1 and lighting device 2 in the X direction. A detailed operation of actuator 9 will be described later.

Roller 3 is rotated by a drive mechanism (not illustrated) to drive conveying belt 8 to convey sheet S in the direction of arrow D.

Rotary encoder 6 detects the rotation speed of roller 4 and detects the movement amount of sheet S conveyed by conveying belt 8. Rotary encoder 6 transmits the detected movement amount of sheet S to image processing device 7.

Image processing device 7 is, for example, a computer. Image processing device 7 determines the size of target object E based on the pixel signal received from imaging device 1 (imaging element 11). Specifically, image processing device 7 executes image extraction processing, image correction processing, and size determination processing to be described later.

### First Exemplary Embodiment

### (Configuration of Imaging Element)

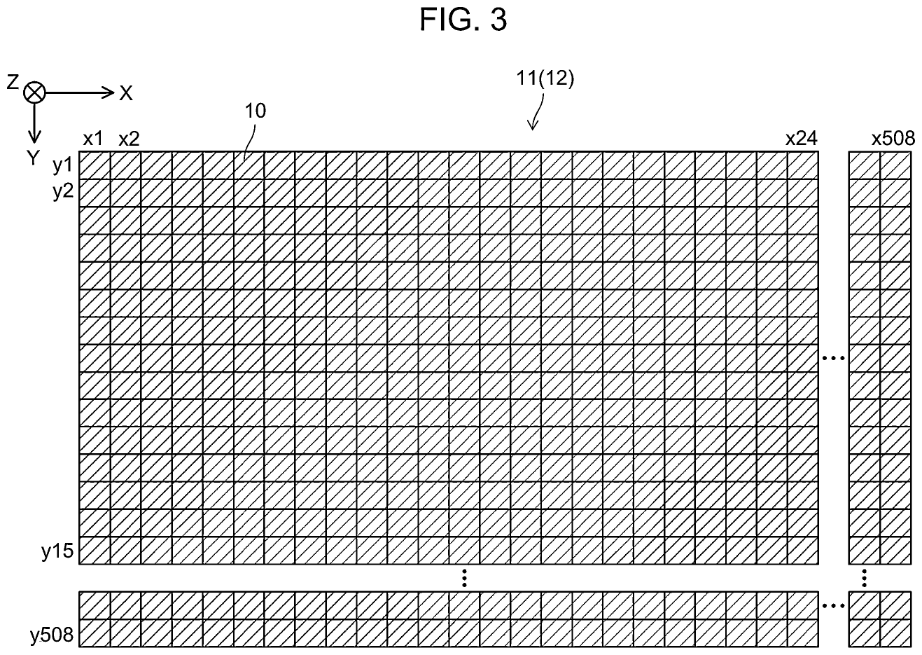

FIG. 3 is a plan view illustrating a configuration of the imaging element according to the first exemplary embodiment. Imaging element 11 is, for example, a complementary MOS (CMOS) sensor.

As illustrated in FIG. 3, imaging element 11 includes pixel array 12 in which m pixels 10 in the X direction and n pixels 10 in the Y direction (in FIG. 3, 508×508 pixels 10) are arranged in a lattice pattern. Note that, in the following description, i-th pixel 10 in the X direction and j-th pixel in the Y direction may be referred to as a pixel (Xi, Yj).

### (Operations of Imaging Device and Lighting Device)

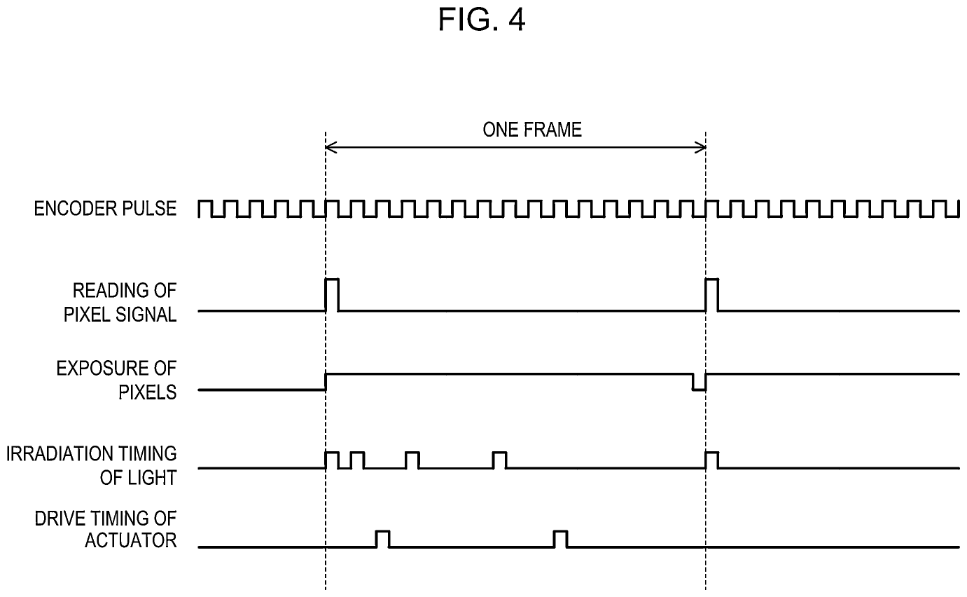

First, operations of imaging device 1, lighting device 2, and actuator 9 when imaging sheet S (inspected object) will be described. FIG. 4 is a timing chart illustrating an imaging timing of the imaging device, an irradiation timing of the lighting device, and a drive timing of the actuator in the inspecting device according to the first exemplary embodiment. In the present exemplary embodiment, the imaging timing of imaging device 1, the irradiation timing of lighting device 2, and the drive timing of actuator 9 are set with reference to an encoder pulse. In the encoder pulse of FIG. 4, one pulse is, for example, 1 μm, but the encoder pulse is not limited thereto.

As illustrated in FIG. 4, exposure of pixel 10 (imaging element 11), reading of a pixel signal, and light irradiation by lighting device 2 are performed in one frame. In a case where imaging device 1 is an area sensor, the reading interval of the pixel signals is set to be equal to or less than the frame rate. Furthermore, in a case where imaging device 1 is an area sensor, the reading interval of the pixel signals is set to be equal to or less than the minimum scan rate. In the present exemplary embodiment, imaging device 1 is an area image sensor, the frame rate is 240 fps (4.17 mesc/time), and the conveyance speed of sheet S is 3000 mm/see or less. That is, the pixel signal is read every 12500 encoder pulses, that is, every 12.5 mm. In this case, the maximum speed at which imaging device 1 can normally perform imaging is 12.5 mm÷(1/240) (sec)=3000 mm/see, and imaging device 1 normally operates at a feeding speed equal to or lower than this.

In addition, as illustrated in FIG. 4, lighting device 2 can emit light a plurality of times in a short time. Specifically, lighting device 2 emits light four times within one photographing time (exposure time). More specifically, lighting device 2 emits the first light after a predetermined pulse (For example, 0 pulses) from the start of exposure. A lighting time at this time is 3 usec. In addition, lighting device 2 emits second light after a predetermined pulse (For example, 513 pulses) from the start of exposure. A lighting time at this time is 3 μsec. Lighting device 2 emits third light after a predetermined pulse (For example, 1500 pulses) from the start of exposure. A lighting time at this time is 3 μsec. In addition, lighting device 2 emits fourth light after a predetermined pulse (For example, 3013 pulses) from the start of exposure. A lighting time at this time is 3 μsec. In the present exemplary embodiment, lighting device 2 emits light four times in one imaging time, but the present invention is not limited thereto, and lighting device 2 may emit light a plurality of times (two or more times) in one imaging time.

In addition, as illustrated in FIG. 4, in order to shift the imaging position of sheet S (target object E), actuator 9 is driven from when lighting device 2 emits light to when lighting device 2 emits next light to change the positions of imaging device 1 and lighting device 2. Specifically, actuator 9 moves the positions of imaging device 1 and lighting device 2 by the resolution+1/N in the X direction from when lighting device 2 emits the second light to when lighting device 2 emits the third light. Then, after lighting device 2 emits the fourth light, actuator 9 moves the positions of imaging device 1 and lighting device 2 by the resolution−1/N in the X direction, and returns imaging device 1 and lighting device 2 to the original positions. Note that, in the present exemplary embodiment, since N=2, the movement amount of actuator 9 in the X direction of imaging device 1 and lighting device 2 is about 13 μm.

By the operations of imaging device 1, lighting device 2, and actuator 9, imaging can be performed with the imaging position of one target object E shifted in the X direction and the Y direction. Specifically, with reference to the position of the image of target object E captured with the first light, the image of target object E captured with the second light is generated at a position offset (Hereinafter, sometimes referred to as a first offset value.) by 0 μm in the X direction and 513 μm in the Y direction, the image of target object E captured with the third light is generated at a position offset (Hereinafter, sometimes referred to as a second offset value.) by 13 μm in the X direction and 1500 μm in the Y direction, and the image of target object E captured with the fourth light is generated at a position offset (Hereinafter, it may be referred to as a third offset value.) by 13 μm in the X direction and 3013 μm in the Y direction.

### (Operation of Image Processing Device)

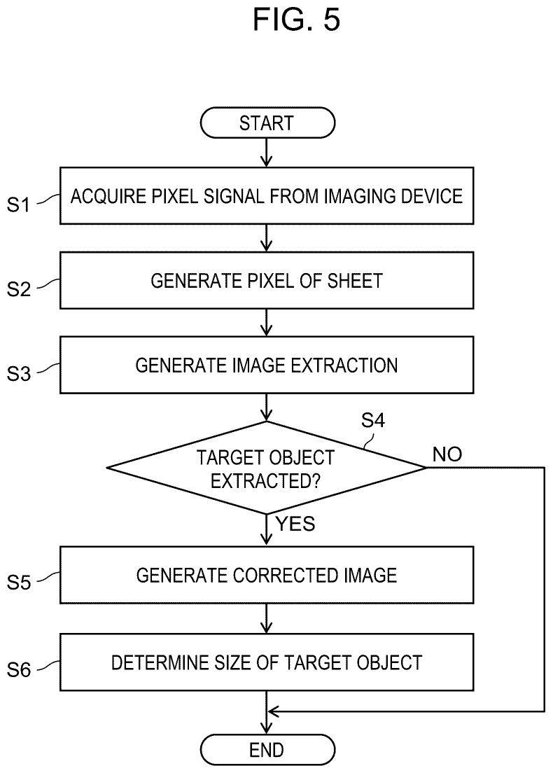

An inspecting method for an inspected object according to the first exemplary embodiment will be described with reference to FIGS. 4 to 9. FIG. 5 is a flowchart for explaining an overall operation flow of the image processing device according to the first exemplary embodiment.

As described above, imaging device 1 (imaging element 11) images sheet S (inspected object) conveyed by conveying belt 8 between rollers 4 and 5. At this time, sheet S is imaged according to the timing chart of FIG. 4. Image processing device 7 acquires (receives) the pixel signal output from imaging device 1 (step S1).

Image processing device 7 generates image P based on the pixel signal acquired from imaging device 1 (step S2). Then, Image processing device 7 executes image extraction processing to be described later, and generates extracted image p from image P (step S3).

Image processing device 7 determines whether or not extracted image p of target object E is included in image P (step S4). Image processing device 7, when determining that extracted image p of target object E is not included in image P (No in step S4), ends the processing. That is, image processing device 7 determines that target object E is not included in sheet S.

When determining that image P includes the image of target object E (Yes in step S4), image processing device 7 generates correction image pw from extracted image p (step S5), and determines the size of target object E (step S6).

### (Image Extraction Processing)

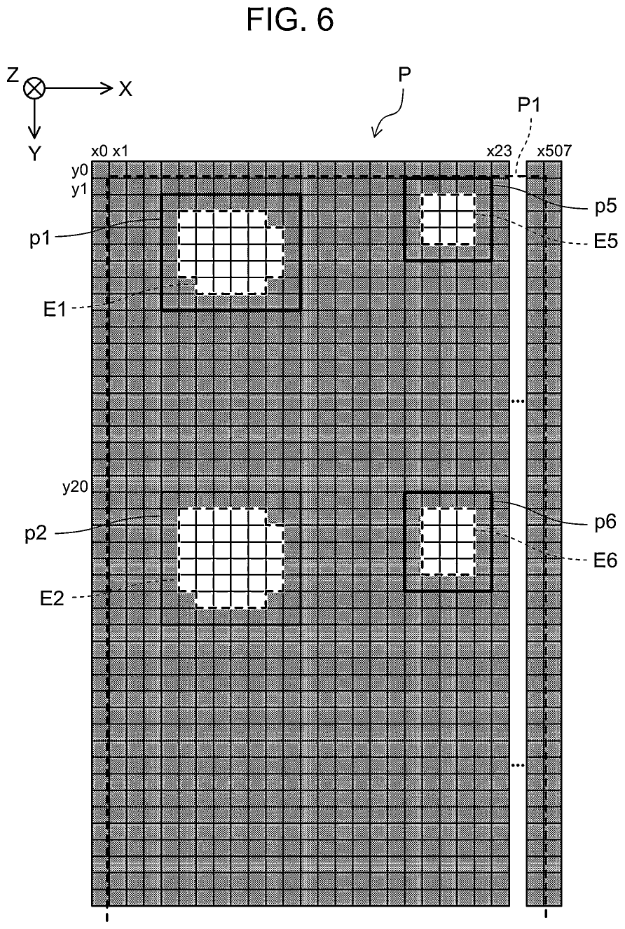

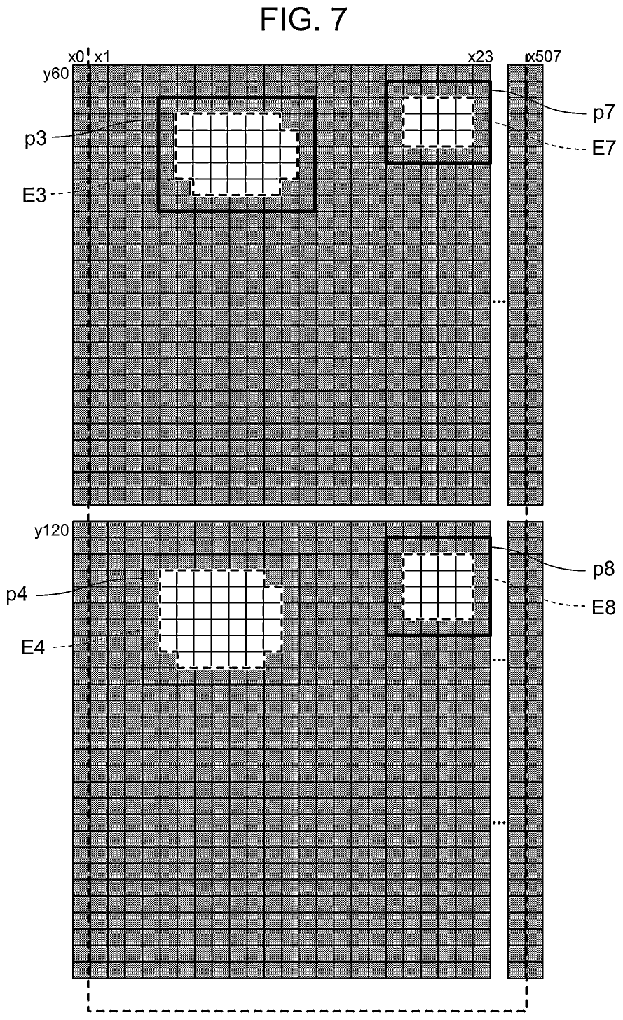

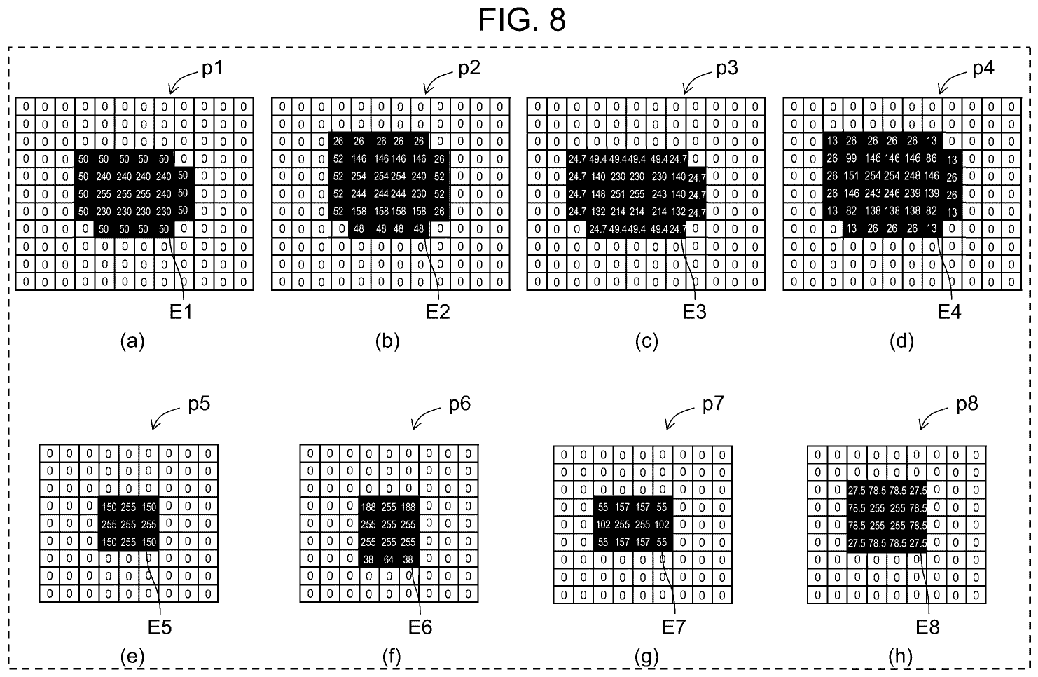

Next, image extraction processing of image processing device 7 will be described with reference to FIGS. 6 to 8. FIGS. 6 to 8 are diagrams illustrating exemplary images of sheets captured by the imaging element according to the first exemplary embodiment. Note that FIG. 6 illustrates a region of the image (x0, y0) to the image (x507, y59) of image P, and FIG. 7 illustrates a region of the image (x0, y60) to the image (x507, y180) of image P. FIGS. 8(a) to 8(h) illustrate extracted images p1 to p8, respectively. Extracted images p1 to p8 are images of captured target objects E1 to E8.

In step S2, image processing device 7 generates image P based on the pixel signal acquired from imaging element 11.

In the present exemplary embodiment, since the lighting time of lighting device 2 is sufficiently shorter than the conveyance speed of rollers 4 and 5, the captured image does not extend in the Y direction. When the lighting time is sufficiently longer than the conveyance speed, image Pi extends in the Y direction. For example, in a case where target object E is imaged at a resolution of 25 μm, a conveyance speed of 2500 mm/sec, and a lighting time of 10 μsec, 2500 (mm/sec)×10 μsec=25 μm, which is longer by approximately 2 pixels in the Y direction.

Then, in step S3, image processing device 7 executes image extraction processing. Specifically, image processing device 7 extracts extracted image p of target object E based on the feature quantity of each image (xi, yj) in image P. Examples of the feature quantity include a luminance value and brightness for each image (xi, yj) in image P. Further, the feature quantity may be determined with reference to the feature quantity of sheet S not including target object E. In addition, the presence or absence of target object E is determined using a feature quantity such as an area value of target object E, a size in the X direction, a size in the Y direction, a shape, and a concentration sum. In the present exemplary embodiment, a case where the feature quantity is a luminance value for each image (xi, yj) in image P will be described as an example.

FIG. 8 illustrates a luminance value for each image (xi, yj) in image P. In FIG. 8, the luminance value is displayed in 256 gradations of 8 bits, and the minimum value of the luminance value is 0 and the maximum value is 255. In FIG. 8, when target object E does not exist on sheet S (ground level), the luminance value is 0.

First, image processing device 7 extracts an image (xi, yj) having a luminance value equal to or greater than a threshold. Then, image processing device 7 sets a plurality of adjacent images (xi, yj) among the extracted images as one target object E. The term “adjacent images” as used herein refers to images that are in contact with one image in the X direction (horizontal direction), the Y direction (vertical direction), and the X direction and Y direction (oblique direction). Specifically, in the case of the image (xi, yj), the images (xi, yj+1), (xi+1, yj), and (xi+1, yj+1) are adjacent images. Image processing device 7 generates extracted image p so as to include extracted target object E.

For example, in a case where the threshold of the luminance value is set to 20, image processing device 7 extracts a region of an image (xi, yj) surrounded by a solid line as an image including target objects E1 to E8 from FIGS. 6 and 7. Then, image processing device 7 generates extracted images p1 to p8 so as to include target objects E1 to E8, respectively (see the respective drawings in FIG. 8).

When generating extracted image p from image P in step S4, image processing device 7 determines that extracted image p of target object E is included in image P.

### (Generation of Corrected Image and Size Determination of Target Object)

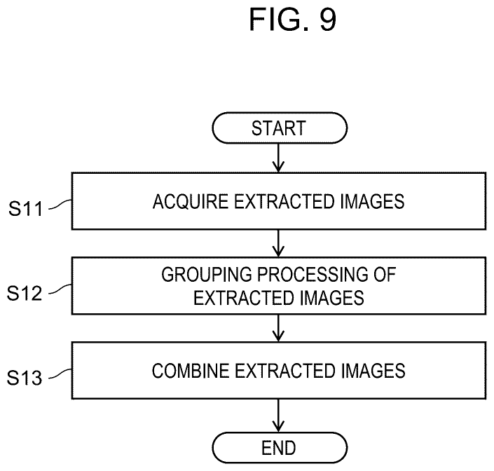

Next, generation processing (step S5) of corrected image pw by image processing device 7 will be described with reference to FIG. 9. FIG. 9 is a flowchart illustrating a flow of generation processing of a corrected image of the image processing device according to the first exemplary embodiment.

When acquiring extracted images p (extracted images p1 to p8 in each drawing of FIG. 8) (step S11), image processing device 7 performs grouping processing of extracted images p (step S12). Specifically, image processing device 7 compares the coordinates of target objects E included in respective extracted images p, and classifies extracted images p satisfying a predetermined condition into the same group. For example, in FIGS. 6 and 7, with reference to extracted image p1, since extracted image p2 is at a position corresponding to the first offset value, extracted image p3 is at a position corresponding to the second offset value, and extracted image p4 is at a position corresponding to the third offset value, extracted images p1 to p4 are classified into the same group. Similarly, with reference to extracted image p5, since extracted image p6 is at a position corresponding to the first offset value, extracted image p7 is at a position corresponding to the second offset value, and extracted image p8 is at a position corresponding to the third offset value, extracted images p5 to p8 are classified into the same group.

As described above, lighting device 2 emits light four times within one exposure time. Therefore, in image P, four extracted images p are generated for one target object E. In addition, lighting device 2 and actuator 9 are driven so that the image of target object E captured by the second light is generated at the position corresponding to the first offset value, the image of target object E captured by the third light is generated at the position corresponding to the second offset value, and the image of target object E captured by the fourth light is generated at the position corresponding to the third offset value with reference to the position of the image of target object E captured by the first light. Therefore, by classifying extracted images p into groups based on the first to third offset values, extracted images p belonging to the same group can be determined to be images indicating the same target object E. That is, in the present exemplary embodiment, it can be determined that target objects E1 to E4 are the same target object and target objects E5 to E8 are the same target object. Further, extracted images p1 to p4 belong to the same group, and extracted images p5 to p8 belong to another group.

After step S12, image processing device 7 doubles extracted images p1 to p8 in the X direction and the Y direction. Then, image processing device 7 superimposes extracted images p belonging to the same group based on the barycentric coordinates of the images to combine extracted images p (step S13). Combined extracted images p become corrected image pw (step S5). More specifically, image processing device 7 combines extracted images p1 to p4 to generate a corrected image of the target object indicated by extracted images p1 to p4. In addition, image processing device 7 combines extracted images p5 to p8 to generate a corrected image of another target object indicated by extracted images p5 to p8.

Then, image processing device 7 determines the size of target object E from generated corrected image pw (step S6). For example, as the size of target object E, an area, a maximum length, an aspect ratio, a vertical width, a horizontal width, a Feret diameter (maximum value, minimum value, etc.), a length of a main shaft (maximum value, minimum value, etc.), and the like are used.

The size of target object E may be determined after the binarization processing is performed on each image of corrected images pw.

As described above, the inspecting device according to the present exemplary embodiment includes imaging device 1 that images sheet S (inspected object) and outputs image P, lighting device 2, rollers 3 to 5 and actuator 9 (movement means), and image processing device 7. Lighting device 2 irradiates sheet S with light a plurality of times in one imaging time. Roller 3 to 5 and actuator 9 change the relative positions of lighting device 2 and imaging device 1 and sheet S in one imaging time. Image processing device 7 extracts images of a plurality of target objects E included in image P, and combines the extracted images of the plurality of target objects E to determine the size of target object E. According to this configuration, in one imaging time, lighting device 2 irradiates sheet S with light a plurality of times, and rollers 3 to 5 and actuator 9 change the relative positions of lighting device 2, imaging device 1, and sheet S. Therefore, the images of the plurality of target objects E are included in image P output from imaging device 1. Then, image processing device 7 combines the images of the plurality of target objects E included in image P.

In one imaging time, lighting device 2 irradiates sheet S with light a plurality of times, and rollers 3 to 5 and actuator 9 change the relative positions of lighting device 2, imaging device 1, and sheet S. Therefore, it is possible to suppress positional shift of target object E due to how the light strikes sheet S. As a result, the image of target object E can be accurately combined, and the size (size) of the target object in the inspected object can be accurately detected. Therefore, the detection reproducibility and the detection probability of the target object (foreign matter or defect) on the inspected object (sheet S) can be improved.

In addition, actuator 9 moves lighting device 2 and imaging device 1 in the X direction perpendicular to the Y direction which is the conveying direction of sheet S. As a result, the relative positions of lighting device 2 and imaging device 1 and sheet S can be changed in both the X direction and the Y direction.

### Second Exemplary Embodiment

The second exemplary embodiment is different from the first exemplary embodiment in the configuration of lighting device 2 and the operation of the image processing device. In the second exemplary embodiment, the same components as those of the first exemplary embodiment are denoted by the same reference numerals, and the description thereof is omitted.

### (Operations of Imaging Device and Lighting Device)

In the second exemplary embodiment, lighting device 2 can emit light beams in different wavelength bands. Specifically, in the second exemplary embodiment, lighting device 2 can emit light beams in the first to third wavelength bands and the reference wavelength band. The first wavelength band is a red wavelength band (625 nm to 780 nm), the second wavelength band is a green wavelength band (500 nm to 565 nm), the third wavelength band is a blue wavelength band (450 nm to 485 nm), and the reference wavelength band is 400 nm to 800 nm. In addition, the reference wavelength band does not necessarily include the entire region of the first wavelength band, the second wavelength band, and the third wavelength band, and may include some wavelength bands. That is, the reference wavelength band may have the wavelength band overlapping with the first wavelength band, the second wavelength band, and the third wavelength band.

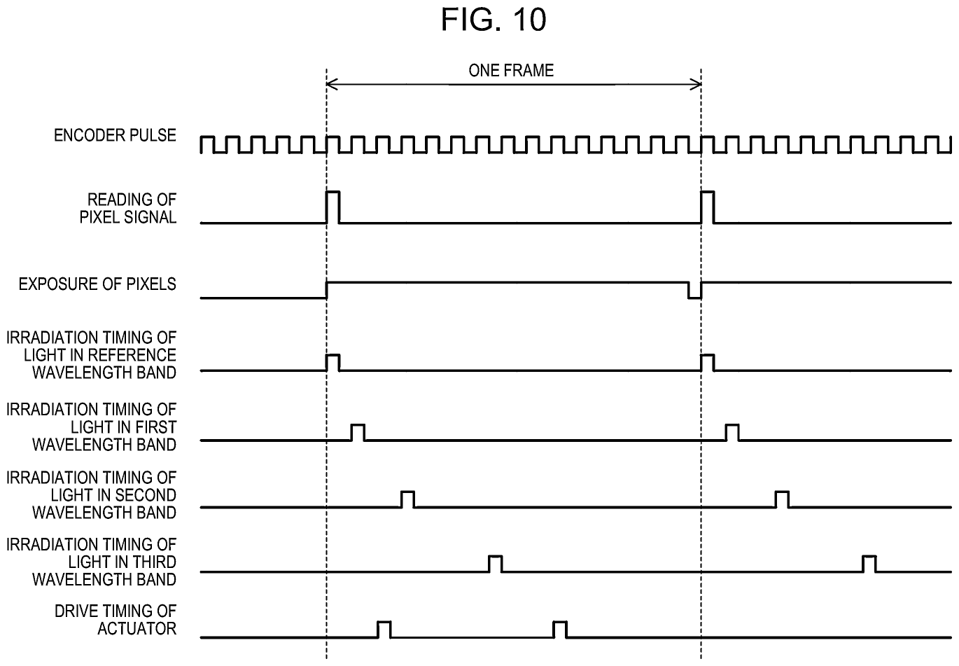

FIG. 10 is a timing chart illustrating an imaging timing of the imaging device, an irradiation timing of the lighting device, and a drive timing of the actuator in the inspecting device according to the first exemplary embodiment. As illustrated in FIG. 10, exposure of imaging element 11, reading of pixel signals, and light irradiation by lighting device 2 are performed in one frame.

Lighting device 2 emits light beams in four different wavelength bands (here, the first to third wavelength bands and the reference wavelength band) at different timings within one exposure time. Specifically, lighting device 2 emits light in the reference wavelength band after a predetermined pulse (for example, 0 pulses) from the start of exposure. A lighting time at this time is 3 μsec. In addition, lighting device 2 emits light in the first wavelength band after a predetermined pulse (for example, 513 pulses) from the start of exposure. A lighting time at this time is 3 μsec. In addition, lighting device 2 emits light in the second wavelength band after a predetermined pulse (for example, 1500 pulses) from the start of exposure. A lighting time at this time is 3 μsec. In addition, lighting device 2 emits light in the third wavelength band after a predetermined pulse (for example, 3013 pulses) from the start of exposure. A lighting time at this time is 3 μsec. Note that the light irradiation order in each wavelength band illustrated in FIG. 10 is merely an example, and lighting device 2 may emit light in any irradiation order in each wavelength band. Furthermore, in the present exemplary embodiment, lighting device 2 emits light beams in four wavelength bands at different timings in one imaging time, but the present invention is not limited thereto, and lighting device 2 may emit light beams in a plurality of (two or more) wavelength bands in one imaging time.

Furthermore, as illustrated in FIG. 10, in order to shift the imaging position of sheet S (target object E), actuator 9 is driven from when lighting device 2 emits light to when lighting device 2 emits next light, thereby changing the positions of imaging device 1 and lighting device 2. Specifically, actuator 9 moves the positions of imaging device 1 and lighting device 2 by the resolution+1/N in the X direction from when lighting device 2 emits light in the first wavelength band to when lighting device 2 emits light in the second wavelength band. Then, after lighting device 2 emits light in the third wavelength band, actuator 9 moves the positions of imaging device 1 and lighting device 2 in the X direction by the resolution−1/N, and returns imaging device 1 and lighting device 2 to the original positions. Note that, in the present exemplary embodiment, since N=2, the movement amount of actuator 9 in the X direction of imaging device 1 and lighting device 2 is about 13 μm.

By the operations of imaging device 1, lighting device 2, and actuator 9, imaging can be performed with the imaging position of one target object E shifted in the X direction and the Y direction. Specifically, with reference to the position of the image of target object E captured with the light in the reference wavelength band, the image of target object E captured with the light in the first wavelength band is generated at a position offset by 0 μm in the X direction and 513 μm in the Y direction (second offset value), the image of target object E captured with the light in the second wavelength band is generated at a position offset by 13 μm in the X direction and 1500 μm in the Y direction (third offset value), and the image of target object E captured with the light in the third wavelength band is generated at a position offset by 13 μm in the X direction and 3013 μm in the Y direction (fourth offset value).

### (Operation of Image Processing Device)

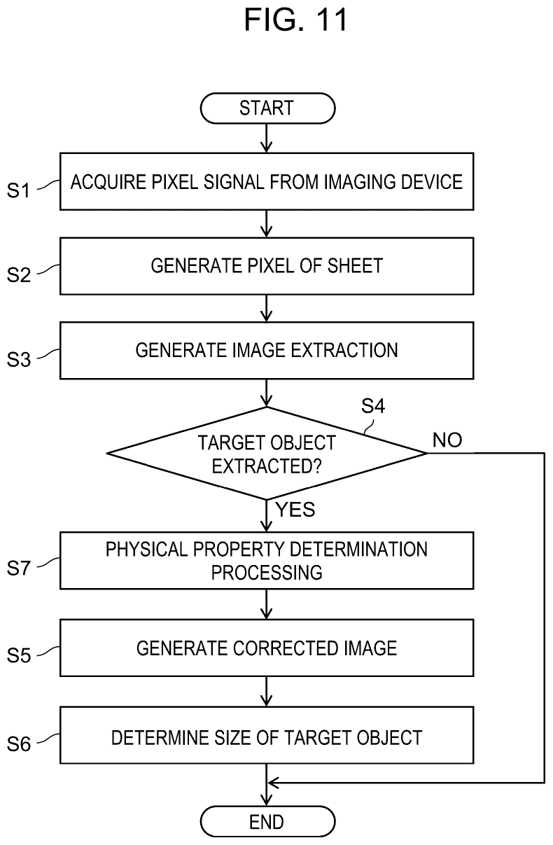

With reference to FIGS. 10 to 19, an inspecting method of an inspected object according to the second exemplary embodiment will be described. FIG. 11 is a flowchart for explaining an overall operation flow of the image processing device according to the second exemplary embodiment.

As shown in FIG. 11, in the inspecting method of an inspected object according to the second exemplary embodiment, when step S4 is Yes, image processing device 7 executes physical property determination processing to be described later (step S7).

### (Image Extraction Processing)

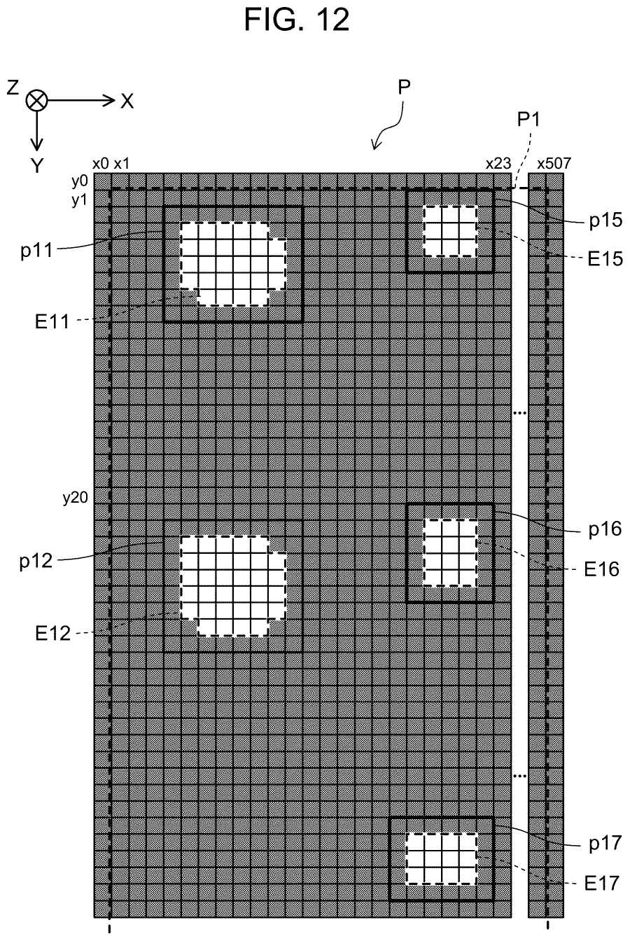

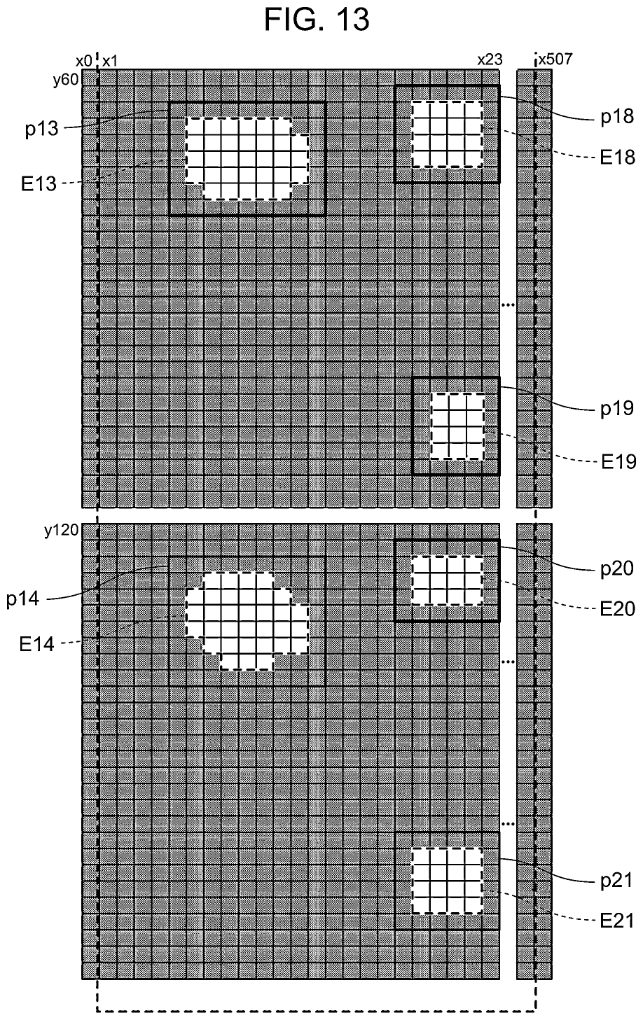

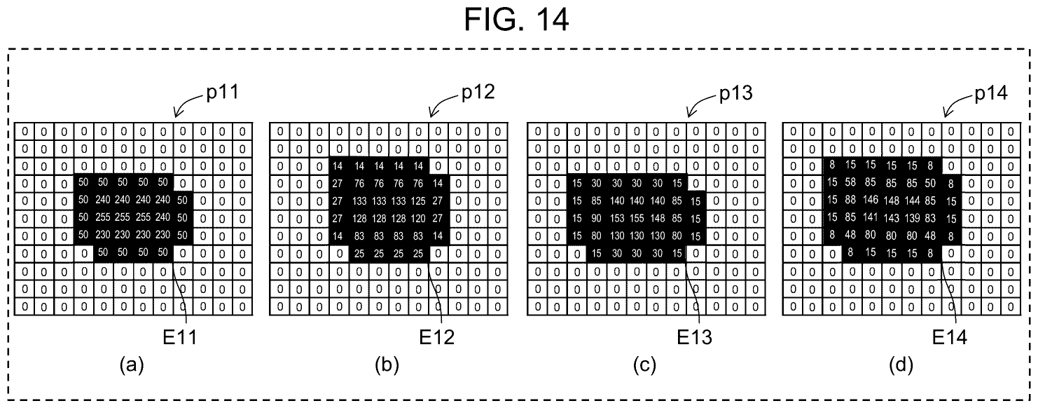

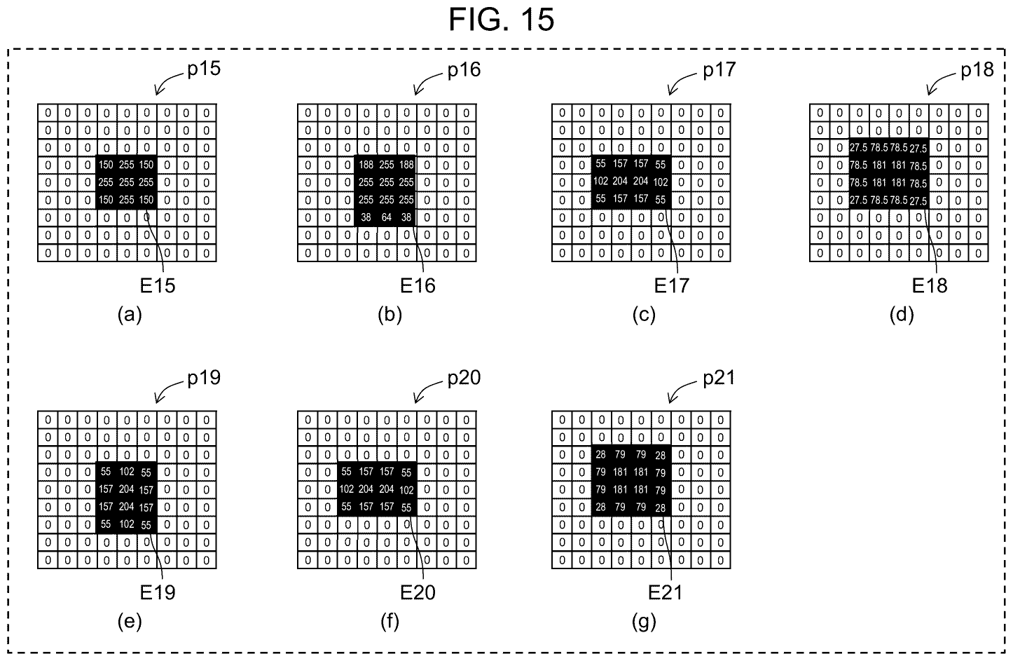

Image extraction processing of image processing device 7 according to the second exemplary embodiment will be described with reference to FIGS. 12 to 17. FIGS. 12 and 13 are diagrams illustrating exemplary images of sheets captured by the imaging element according to the second exemplary embodiment. FIGS. 14 and 15 are diagrams illustrating examples of luminance values of extracted images according to the second exemplary embodiment. Note that FIG. 12 illustrates a region of an image (x0, y0) to an image (x507, y59) of image P, and FIG. 13 illustrates a region of an image (x0, y60) to an image (x507, y180) of image P. FIGS. 14(a) to 14(d) and FIGS. 15(a) to 15(g) illustrate extracted images p11 to p21 of FIGS. 12 and 13, respectively. In addition, the target objects illustrated in extracted images p11 to p21 are set as target objects E11 to E21, respectively.

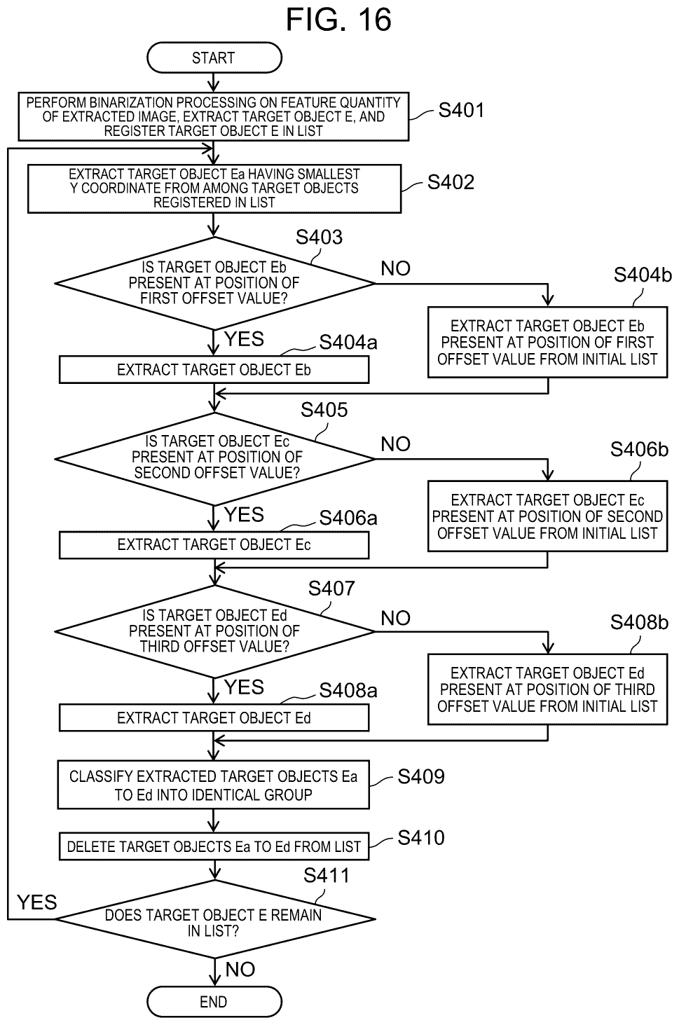

As described above, lighting device 2 emits the light beams in the first to third wavelength bands and the reference wavelength band at different timings within one exposure time. Therefore, in image P, extracted images of the number of target objects×4 are generated. However, only 11 extracted images are formed in FIGS. 12 to 15. This is considered to be because images of different target objects E (extracted image p16 in FIG. 12) overlap due to two target objects E being in the vicinity of the same X coordinate. Therefore, in the second exemplary embodiment, grouping processing (FIG. 16) of extracted images (target objects) different from that of the first exemplary embodiment is performed. As a result, target object E can be extracted without omission.

FIG. 16 is a flowchart illustrating grouping processing according to the second exemplary embodiment.

First, image processing device 7 performs binarization processing on extracted images p11 to p21 with a predetermined feature quantity as a threshold (for example, 20), extracts target objects E11 to E21 from each of the extracted images, and registers the extracted target objects in a list (step S401). Examples of the feature quantity at this time include a luminance value, a position of a target object, a fillet diameter, and the like. In the present exemplary embodiment, a case where the feature quantity is a luminance value will be described as an example.

Next, image processing device 7 extracts target object Ea having the smallest Y coordinate among target objects E registered in the list (step S402). Then, image processing device 7 determines whether or not target object Eb exists at the position of the first offset value with reference to the X and Y coordinates of target object Ea (step S403). The first offset value refers to a distance caused by a difference in timing at which lighting device 2 emits the light in the reference wavelength band and the light in the first wavelength band.

When determining that target object Eb exists at the position of the first offset value (Yes in step S403), image processing device 7 extracts target object Eb (step S404a). On the other hand, when determining that target object Eb does not exist at the position of the first offset (No in step S403), image processing device 7 reads the initial list, and extracts target object Eb existing at the position of the first offset value with reference to the X and Y coordinates of target object Ea (step S404a). As will be described in detail later, the extracted target object is deleted from the list. Therefore, when the target objects overlap (for example, target object E16 of FIG. 12), the target object may have already been deleted from the list. Here, in order to extract target object E without omission, target object Eb is extracted from the initial list. Note that, in the processing of steps S406b and S408b described below, substantially the same processing as that of step S404a is performed for the same reason.

After steps S404a and S404b, image processing device 7 determines whether or not target object Ec exists at the position of the second offset value with reference to the X and Y coordinates of target object Ea (step S405). The second offset value refers to a distance caused by a difference in timing at which lighting device 2 emits light in the reference wavelength band and light in the second wavelength band and driving of actuator 9. When determining that target object Ec exists at the position of the second offset value (Yes in step S405), image processing device 7 extracts target object Ec (step S406a). On the other hand, when determining that target object Ec does not exist at the position of the second offset (No in step S405), image processing device 7 reads the initial list, and extracts target object Ec existing at the position of the second offset value with reference to the X and Y coordinates of target object Ea (step S406a).

After steps S406a and S406b, image processing device 7 determines whether or not target object Ed exists at the position of the third offset value with reference to the X and Y coordinates of target object Ea (step S407). The third offset value refers to a distance caused by a difference in timing at which lighting device 2 emits light in the reference wavelength band and light in the third wavelength band and driving of actuator 9. When determining that target object Ed exists at the position of the third offset value (Yes in step S407), image processing device 7 extracts target object Ed (step S408a). On the other hand, when determining that target object Ed does not exist at the position of the third offset (No in step S407), image processing device 7 reads the initial list, and extracts target object Ed existing at the position of the third offset value with reference to the X and Y coordinates of target object Ea (step S408a).

After steps S406a and S406b, image processing device 7 classifies extracted target objects Ea to Ed into the same group (step S409). Then, image processing device 7 deletes extracted target objects Ea to Ed from the list (step S410).

After step S410, image processing device 7 determines whether a target object remains in the list (step S411). When determining that the target object remains in the list (Yes in step S411), image processing device 7 returns to step S401 and performs the grouping processing again. Image processing device 7, when determining that no target object remains in the list (YNo in step S411), ends the processing. That is, image processing device 7 performs the grouping processing until all the target objects are classified. By this grouping, target objects E classified into the same group indicate the same target object E.

When the initial list is read and target object Eb does not exist at the position of the first offset value with reference to the X and Y coordinates of target object Ea in step S404b, it is considered that target object Ea is not generated by emitting the light in the reference wavelength band but is generated by emitting any one of the light beams in the first to third wavelength bands. In this case, image processing device 7 extracts the target objects at the positions in the first to third offset values from the initial list with reference to the X and Y coordinates of target object Ea. The extracted target object is set as target object Ea, and the processing in and after step S403 is performed again. As described above, the first to third offset values are set to different values. Therefore, only one true target object Ea is extracted. Note that the offset position where the grouping processing is performed may have a width in order to reliably extract the image of target object E.

For example, in FIGS. 12 and 13, target objects E11 to E21 are registered in the initial list, and target objects E15, E16, E18, and E20 are classified into the same group by the first grouping processing. Next, by the second grouping processing, target objects E11 to E14 are classified into the same group. Then, in the third grouping processing, target object E17 is determined as target object Ea. At this time, none of target objects E19 and E21 remaining in the list exist at the position of the first offset value when target object E17 is used as a reference. Therefore, image processing device 7 cannot extract target object Eb. Therefore, image processing device 7 extracts target object E at the positions of the first to third offsets with reference to target object E17. At this time, when target object E17 is used as a reference, image processing device 7 determines target object E16 as true target object Ea since target object E16 exists at the position of the first offset. As a result, image processing device 7 executes the processing in and after step S403 with target object E16 as target object Ea, and classifies target objects E16, E17, E19, and E21 into the same group.

Here, since lighting device 2 emits light in the order of the light beams in the reference wavelength band and the first to third wavelength bands, target objects E (extracted images p) classified into the same group can be determined as an extracted image (hereinafter, referred to as a “reference image”) in which extracted image p having the smallest Y coordinate is generated by emitting the light beam in the reference wavelength band, an extracted image (hereinafter, referred to as a “first image”) in which extracted image p having the second smallest Y coordinate is generated by emitting the light beam in the first wavelength band, an extracted image (hereinafter, referred to as a “second image”) in which extracted image p having the third smallest Y coordinate is generated by emitting the light beam in the third wavelength band, and an extracted image (hereinafter, referred to as a “third image”) in which extracted image p having the largest Y coordinate is generated by emitting the light beam in the third wavelength band. For example, in FIGS. 12 to 15, the reference images are extracted images p11, p15, and p16, the first images are extracted images p12, p16, and p17, the second images are extracted images p13, p18, and p19, and the third images are extracted images p14, p20, and p21.

Next, generation processing of an original extracted image will be described.

In the grouping processing described above, in a case where one target object E is classified into a plurality of groups, extracted images p of overlapping target objects E are grouped. In this case, physical property determination processing to be described later cannot be executed from extracted images p of overlapping target objects E. Therefore, image processing device 7 performs processing of generating extracted images p of original target object E. In FIG. 5, the processing after step S4 is performed using extracted images p generated by this processing.

In one of the generation processing of an original extracted image, for example, in a case where the reference image has an overlap with another extracted image p, the original reference image can be generated by combining the first to third images belonging to the same group. For example, in FIG. 14, extracted image p11 can be generated by combining extracted images p12 to p14.

In addition, in a case where an extracted image of any one of the first to third images has an overlap with another extracted image p, it is possible to generate the extracted image by subtracting the extracted image having no overlap with another extracted image p among the first to third images from the reference image. For example, in FIG. 14, extracted image p12 can be generated by subtracting the feature quantities of extraction images p13 and p14 from the feature quantity of extracted image p11.

Furthermore, in a case where the extracted image of any one of the first to third extracted images has an overlap with another extracted image p, the extracted image can be generated from the calculable reflectance (to be described in detail later) of target object E. As will be described in detail later, in extracted images p belonging to the same groove, an image having the largest feature quantity among the reference images is defined as an image δ, an image having the largest feature quantity among the first images is defined as an image α, an image having the largest feature quantity among the second images is defined as an image β, and an image having the largest feature quantity among the third images is defined as an image γ. In this case, reflectance R of target object E in the first wavelength band is (luminance value of image α)/(luminance value of image δ). Reflectance R of target object E in the second wavelength band is (luminance value of image β)/(luminance value of image δ). Reflectance R of target object E in the third wavelength band is (luminance value of image β)/(luminance value of image δ).

For example, in FIGS. 12 to 15, in extracted image p16, images of two target objects E overlap. Therefore, extracted image p16 cannot be used as the first image of target object E15.

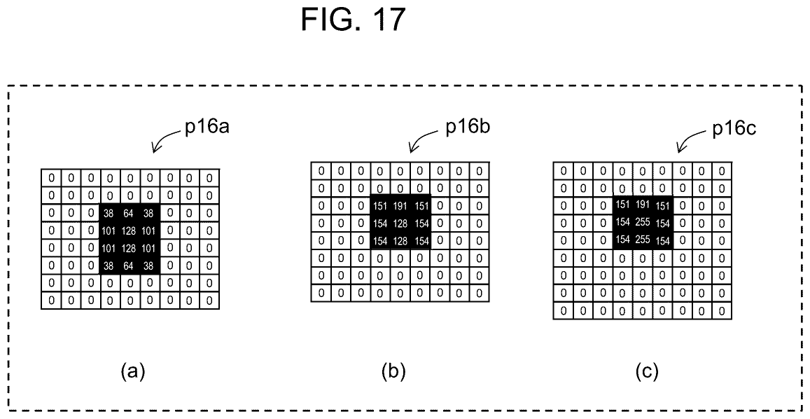

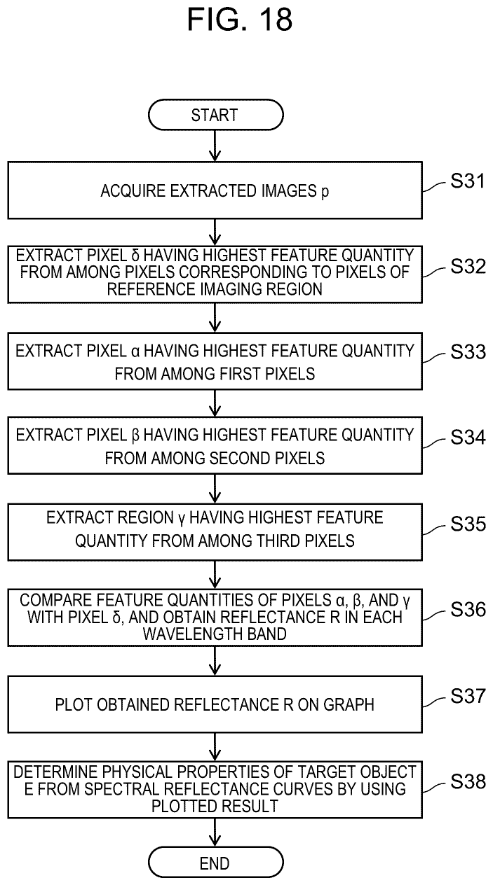

Here, as illustrated in FIGS. 14 and 15, from extracted images p15 and p18 (second image), since reflectance R22 of target object E15 (E18, E20) in the second wavelength band is 150/255≈0.59, reflectance R22 is 59%. From extracted images p15 and p20 (third image), since reflectance R23 of target object E15 in the third wavelength band is 204/255 ≈0.8, reflectance R23 is 80%. Here, referring to the spectral reflectance curve in FIG. 18, it can be determined that target object E15 is Cu. As a result, it can be determined that reflectance R21 of target object E15 in the first wavelength band is about 50%. By multiplying the feature quantity (luminance value) of extracted image p15 by reflectance R23, extracted image p16a (see FIG. 17(a)) of target object E15 in the first wavelength band can be generated.

Furthermore, the reference image of target object E17 can be generated by subtracting estimated extracted image p16a from extracted image p16. However, in this image generating method, as illustrated in FIG. 17(b), the luminance value of the central portion of the image becomes higher than that of the peripheral portion of the image, and extracted image p16b cannot be correctly estimated. This is considered to be because the highest luminance value exceeds 255 as a result of overlapping of two target objects E16 and E17 in extracted image p16. Therefore, the reference image of target object E17 can be estimated using extracted image p18 belonging to the same group as target object E17 and having no overlap. Specifically, by multiplying the entire image of extracted image p18 by the maximum magnification (image a2/image a1=150/110) of extracted images p16b and p18, extracted image p16c (FIG. 17(c)) of target object E17 in the reference wavelength band can be generated.

### (Physical Property Determination Processing)

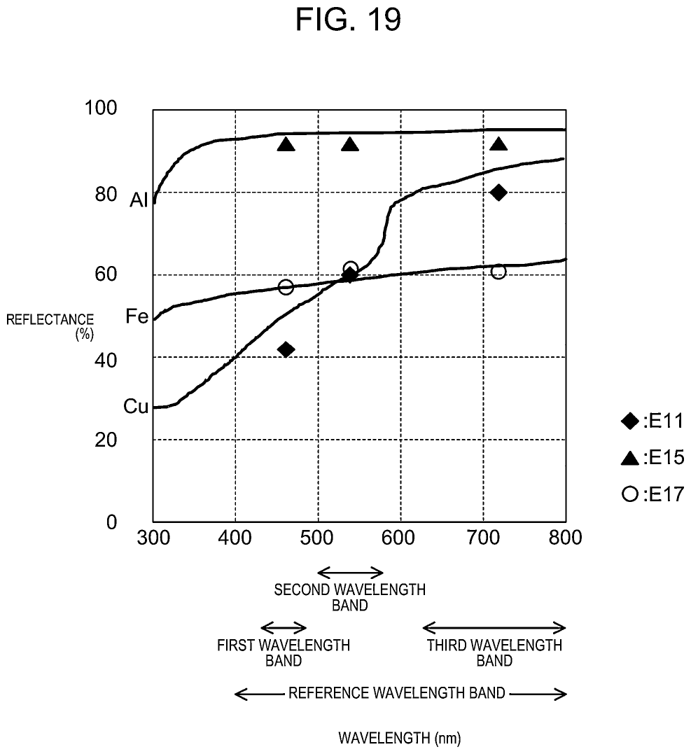

Physical property determination processing (step S7) of image processing device 7 according to the second exemplary embodiment will be described with reference to FIGS. 18 and 19. FIG. 18 is a flowchart illustrating a flow of physical property determination processing of the image processing device according to the second exemplary embodiment.

When extracted images p (in FIG. 18, extracted images p11 to p21 and the estimated extracted image) are acquired (step S31), image processing device 7 extracts image 8 having the highest feature quantity from among the images included in the reference image (extracted image p having the smallest Y coordinate) in extracted images p belonging to the same group (step S32).

Image processing device 7 extracts image α having the highest feature quantity among images included in the first image (extracted image p having the second smallest Y coordinate) in extracted images p belonging to the same group (step S33).

Image processing device 7 extracts image β having the highest feature quantity among images included in the second image (extracted image p having the third smallest Y coordinate) in extracted images p belonging to the same group (step S34).

Image processing device 7 extracts image γ having the highest feature quantity among the images included in the third image (extracted image p having the largest Y coordinate) in extracted images p belonging to the same group (step S35).

For example, in FIG. 18, extracted images p11 to p14 are classified into the same group. In FIG. 18, in extracted images p11 to p14, image δ4 of extracted image p11 corresponds to image δ, image α4 of extracted image p12 corresponds to image α, image β4 of extracted image p13 corresponds to image β, and image γ4 of extracted image p14 corresponds to image γ.

After step S35, reflectances R31 to R33 of target object E11 (E12 to E14) in the first wavelength band, the second wavelength band, and the third wavelength band are obtained based on the luminance values of image δ and images α, β, and γ (step S36). Specifically, reflectance R31 can be obtained by (luminance value of image α)/(luminance value of image δ). Reflectance R32 can be obtained by (luminance value of image β)/(luminance value of image δ). Reflectance R33 can be obtained by (luminance value of image γ)/(luminance value of image δ).

For example, in FIG. 18, reflectance R31 of target object E11=133/255≈0.52, and reflectance R31 of target object E11 is 55%. Reflectance R32 of target object E1=155/255≈0.60, and reflectance R32 of target object E11 is 60%. Reflectance R33 of target object E11 is 148/255≈0.58, and reflectance R33 of target object E11 is 58%. Similarly, reflectance R can be obtained for each of target objects E15 and E17.

After step S36, the reflectances are plotted on a graph (step S37). Obtained reflectance R in each wavelength band is plotted on a graph with the wavelength on the X-axis and reflectance R on the Y-axis. In the present exemplary embodiment, reflectance R in each wavelength band is plotted as a median value of the wavelength band (see FIG. 19).

As illustrated in FIG. 19, the plotted reflectances are compared with the spectral reflectance curve, the closest spectral reflectance curve is selected from the correlation, and the physical property of target object E is determined based on the spectral reflectance curve (step S38). The plot of reflectances of target object E11 (E12 to E14) is closest to the spectral reflectance curve of Fe. Therefore, image processing device 7 determines that target object E11 is Fe. The plot of reflectances of target object E15 (E16, E18, and E20) is closest to the spectral reflectance curve of Al. Therefore, image processing device 7 determines that target object E15 is Al. The plot of reflectances of target object E17 (E16, E19, and E21) is closest to the spectral reflectance curve of Cu. Therefore, image processing device 7 determines that target object E17 is Cu.

### (Size Determination of Target Object)

Next, size determination processing (step S6) of target object E of the image processing device according to the second exemplary embodiment will be described.

As described above, target objects E11 to E14 (FIGS. 12(a) to 12(d)) are the same object, and extracted images p11 to p14 are images obtained by imaging the same target object with light beams in different wavelength bands. That is, by multiplying the luminance value of each of extracted images p12 to p14 by the reciprocal of the reflectance (ratio of the maximum luminance value), extracted images p12 to p14 can be corrected to images having luminance values similar to those of the images captured with the light in the reference wavelength band.

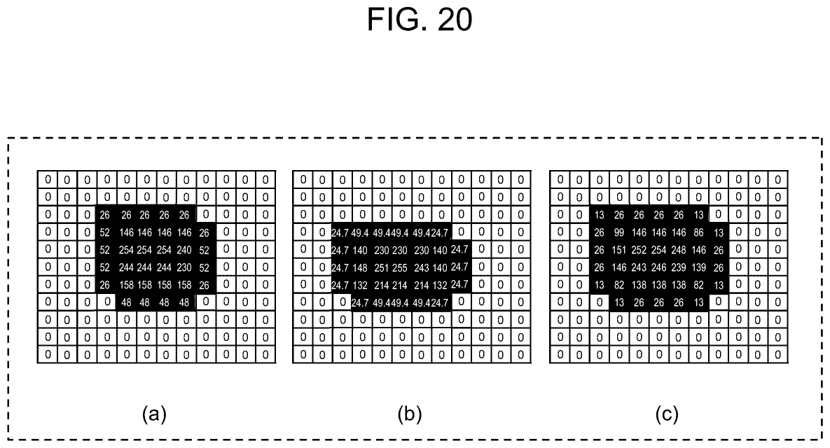

As described above, the maximum luminance value of the pixel in extracted image p11 (FIG. 12(a)) is 255, the maximum luminance value of the pixel in extracted image p12 (FIG. 12(b)) is 140, the maximum luminance value of the pixel in extracted image p13 (FIG. 12(c)) is 155, and the maximum luminance value of the pixel in extracted image p14 (FIG. 12(d)) is 155. Therefore, each of extracted images p12 is multiplied by 255/140, each of extracted images p13 is multiplied by 255/155, and each of extracted images p14 is multiplied by 255/155. As a result, extracted images p12 to p14 are corrected to extracted images p12′ to p14′ (see FIGS. 20(a) to 20(c)). Image processing device 7 generates corrected image pw using extracted image p11 and corrected extracted images p12′ to p14′. Then, image processing device 7 determines the size of target object E.

As described above, the inspecting device according to the present exemplary embodiment includes imaging device 1 that images sheet S (inspected object) and outputs image P, lighting device 2, rollers 3 to 5 and actuator 9 (movement means), and image processing device 7. Lighting device 2 can emit light in a first wavelength band, light in a second wavelength band, light in a third wavelength band, and light in a reference wavelength band having a wavelength band overlapping with the first, second, and third wavelength bands. The lighting device irradiates sheet S with the light in the first wavelength band, the light in the second wavelength band, the light in the third wavelength band, and the light in the reference wavelength band at different timings in one imaging time. Image processing device 7 calculates a first reflectance that is a reflectance in the first wavelength band, a second reflectance that is a reflectance in the second wavelength band, and a third reflectance that is a reflectance in the third wavelength band of target object E based on the image output from the imaging device 1, and determines physical properties of target object E based on the first reflectance, the second reflectance, and the third reflectance. According to this configuration, lighting device 2 irradiates sheet S with the light in the first wavelength band, the light in the second wavelength band, and the light in the reference wavelength band at different timings in one imaging time, whereby extracted image p of target object E with the light in the first wavelength band, extracted image p of target object E with the light in the second wavelength band, extracted image p of target object E with the light in the third wavelength band, and extracted image p of target object E with the light in the basic wavelength band are formed in image P. Since reflectances R31, R32, and R33 of target object E in the first, second, and third wavelength bands can be obtained based on four extracted images p, the physical properties of target object E can be determined. In addition, since image P includes extracted image p of target object E by the light in the first wavelength band, extracted image p of target object E by the light in the second wavelength band, extracted image p of target object E by the light in the third wavelength band, and extracted image p of target object E by the light in the basic wavelength band, it is not necessary to photograph sheet S for each wavelength band, and an increase in the photographing time can be suppressed. Therefore, it is possible to determine the physical properties of the target object while suppressing an increase in the imaging time.

In addition, image processing device 7 determines the physical properties of target object E by comparing reflectances R31, R32, and R33 with spectral reflectance data indicating spectral reflectances of a plurality of substances. This makes it possible to more accurately determine the physical properties of target object E.

Further, when a plurality of target objects E are present on sheet S, image processing device 7 generates the remaining one image from any two of the first image that is extracted image p of target object E by the light in the first wavelength band, the second image that is extracted image p of target object E by the second wavelength band, the third image that is extracted image p of target object E by the third wavelength band, and the reference image that is extracted image p of target object E by the reference wavelength band. As a result, in image P generated from the pixel signal, even when any one of the first image, the second image, the third image, and the reference image overlaps extracted image p of other target object E, the image can be generated from the other images except for the image among the first image, the second image, the third image, and the reference image.

In addition, image processing device 7 combines the feature quantities of the first image, the second image, and the third image to generate the reference image. As a result, even when the reference image overlaps another extracted image p in image P, the reference image can be generated from the first image, the second image, and the third image.

In addition, image processing device 7 generates the third image by subtracting the feature quantity of the first image from the feature quantity of the reference image. As a result, even when the first image has an overlap with another extracted image p in image P, the first image can be generated from the reference image and the second image.

When a plurality of target objects E are present on sheet S, image processing device 7 classifies the first image, the second image, and the reference image for each of the plurality of target objects E. In addition, image processing device 7 calculates the first reflectance, the second reflectance, and the third reflectance based on the first image, the second image, the third image, and the reference image classified into the same group. As a result, when a plurality of target objects E are present on sheet S, physical properties can be determined for each target object E.

### Other Exemplary Embodiments

As described above, the exemplary embodiments have been described as examples of the technology disclosed in the present application. However, the technology in the present disclosure is not limited thereto, and can also be applied to exemplary embodiments in which changes, replacements, additions, omissions, and the like are made as appropriate.

In the above exemplary embodiment, imaging device 1 and lighting device 2 are configured by the dark field optical system, but may be configured by the bright field optical system. Furthermore, imaging device 1 is configured as a line sensor, but may be configured as an area sensor. Furthermore, image processing device 7 may generate a moving image or a still image from a pixel signal output from imaging element 11.

Furthermore, the arrangement of pixels 10 arranged in imaging element 11 is not limited to the above-described arrangement. Furthermore, the number of pixels of imaging element 11 is not limited to the above-described number.

Furthermore, in each of the above exemplary embodiments, rollers 3 to 5 and actuator 9 have been described as an example of the movement means, but the movement means is not limited thereto, and any movement means may be used as long as the relative position between sheet S and imaging device 1 and lighting device 2 can be changed.

### INDUSTRIAL APPLICABILITY

The inspecting device of the present disclosure can be used for inspection of foreign substance or defects included in members used for semiconductors, electronic devices, secondary batteries, and the like.

### REFERENCE MARKS IN THE DRAWINGS

A: inspecting device
1: imaging device
2: lighting device
3 to 5: roller (movement means)
7: image processing device
9: actuator (movement means)
10: pixel
11: imaging element
E (E1 to E8, E11 to E21): target object
P: image
p (p1 to p8, p11 to p21, p16a to p16c): extracted image
pw: corrected image

1. An inspecting method for detecting a target object included in an inspected object by capturing an image of the target object with an inspecting device,
the inspecting device including:
an imaging device that captures an image of the inspected object and outputs the image;
a lighting device;
movement means; and
an image processing device, and
the method comprising:
an irradiation step of irradiating, by the lighting device, the inspected object with light a plurality of times in one imaging time;
a movement step of changing, by the movement means, relative positions of the lighting device, the imaging device, and the inspected object in the one imaging time; and
a determination step of extracting, by the image processing device, a plurality of images of the target object included in the image output by the imaging device, and combining the plurality of extracted images of the target object to determine a size of the target object.

2. The inspecting method according to claim 1, wherein
the inspecting device further includes an actuator that changes positions of the lighting device and the imaging device,
the method further comprising moving, by an actuator, the lighting device and the imaging device in a direction perpendicular to a conveying direction of the inspected object in the movement step.

3. The inspecting method according to claim 1, wherein
the lighting device is capable of emitting light in a first wavelength band, light in a second wavelength band, light in a third wavelength band, and light in a reference wavelength band having a wavelength band overlapping with the first, second, and third wavelength bands,
the method further comprising:
irradiating, by the lighting device, the inspected object with the light in the first wavelength band, the light in the second wavelength band, the light in the third wavelength band, and the light in the reference wavelength band at different timings in the one imaging time in the irradiation step, and
calculating, by the image processing device, a first reflectance that is a reflectance in the first wavelength band, a second reflectance that is a reflectance in the second wavelength band, and a third reflectance that is a reflectance in the third wavelength band of the target object based on the image output from the imaging device, and determining a physical property of the target object based on the first reflectance, the second reflectance, and the third reflectance in the determination step.

4. The inspecting method according to claim 3, further comprising
a step of comparing, by the image processing device, the first reflectance, the second reflectance, and the third reflectance with spectral reflectance data indicating spectral reflectances of a plurality of substances to determine the physical property of the target object.

5. The inspecting method according to claim 3, further comprising
a step of generating, by the image processing device, a remaining one image from any two of a first image that is an image of the target object by light in the first wavelength band, a second image that is an image of the target object by the second wavelength band, a third image that is an image of the target object by the third wavelength band, and a reference image that is an image of the target object by the reference wavelength band in a case where a plurality of the target objects are present on the inspected object.

6. The inspecting method according to claim 5, further comprising
a step of combining, by the image processing device, feature quantities of the first image, the second image, and the third image to generate the reference image.

7. The inspecting method according to claim 5, further comprising
a step of subtracting, by the image processing device, a feature quantity of the first image from a feature quantity of the reference image to generate the third image.

8. The inspecting method according to claim 6, wherein
the feature quantity is a luminance value or brightness of the target object.

9. The inspecting method according to claim 3, further comprising:
a step of generating, by the image processing device, the first image that is the image of the target object by the light in the first wavelength band, the second image that is the image of the target object by the second wavelength band, the third image that is the image of the target object by the third wavelength band, and the reference image that is the image of the target object by the reference wavelength band for each of the plurality of target objects in a case where a plurality of the target objects are present on the inspected object;
a step of classifying, by the image processing device, the first image, the second image, the third image, and the reference image for each of the plurality of target objects; and
a step of calculating, by the image processing device, the first reflectance and the second reflectance based on the first image, the second image, the third image, and the reference image classified into the same group.

10. An inspecting device that detects a target object included in an inspected object, the inspecting device comprising:
an imaging device that captures an image of the inspected object and outputs the image;
a lighting device;
movement means; and
an image processing device, wherein
the lighting device irradiates the inspected object with the plurality of times of light in one imaging time,
the movement means changes relative positions of the lighting device, the imaging device, and the inspected object in the one imaging time, and
the image processing device extracts a plurality of images of the target object included in the image output by the imaging device, and combines the plurality of extracted images of the target object to determine a size of the target object.

11. The inspecting device according to claim 10, wherein
the movement means is a roller that conveys an inspected object.

12. The inspecting device according to claim 10, further comprising
an actuator that moves the lighting device and the imaging device.
